(19) United States
(12) Patent Application Publication
(10) Pub. No.: US 2015/0173109 A1
(43) Pub. Date: Jun. 18, 2015

(54) APPARATUS, METHOD AND SYSTEM OF COMMUNICATING VIA AN APPLICATION SERVICE PLATFORM (ASP) SESSION

(71) Applicant: INTEL CORPORATION, Santa Clara, CA (US)

(72) Inventors: Ganesh Venkatesan, Hillsboro, OR (US); Carlos Cordeiro, Portland, OR (US); David J. McCall, Dallas, TX (US); Emily H. Qi, Camas, WA (US)

(21) Appl. No.: 14/472,413

(22) Filed: Aug. 29, 2014

Related U.S. Application Data
(60) Provisional application No. 61/916,399, filed on Dec. 16, 2013.

(51) Int. Cl. H04W 76/02

(52) U.S. Cl. CPC H04W 76/02; H04W 84/12

(57) ABSTRACT

Some demonstrative embodiments include devices, systems and methods of communicating via an Application Service Platform (ASP) session. For example, a first device may include a radio to communicate over a Wireless Local Area Network (WLAN); and a controller to establish an ASP Peer-to-Peer (P2P) (ASP-P2P) session between the first device and a second device via a WLAN Access Point (AP), the radio to communicate at least one frame with the second device via the WLAN AP, the frame including an address of the first device, an address of the second device, and an identifier of the WLAN AP.

### CROSS REFERENCE

This Application claims the benefit of and priority from U.S. Provisional Patent Application No. 61,916,399 entitled “Wireless Device and Method to Establish WFDS ASP Session Through AP Infrastructure Network”, filed Dec. 16, 2013, the entire disclosure of which is incorporated herein by reference.

### TECHNICAL FIELD

Embodiments described herein generally relate to communicating via an Application Service Platform (APS) session.

### BACKGROUND

A first wireless communication device may be capable of providing one or more services to a second wireless communication device. For example, the first wireless communication device may provide printing services, display services, Internet access services, and/or any other service to the second wireless communication device.

Wireless Fidelity (Wi-Fi) Direct (WFD) Services (WFDS) technology provides a Peer-to-Peer (P2P) connectivity to connect between the first and second devices, e.g., to share, show, print, and/or synchronize content.

However, in some systems a direct wireless connection may not be the best and/or most efficient connection.

### BRIEF DESCRIPTION OF THE DRAWINGS

For simplicity and clarity of illustration, elements shown in the figures have not necessarily been drawn to scale. For example, the dimensions of some of the elements may be exaggerated relative to other elements for clarity of presentation. Furthermore, reference numerals may be repeated among the figures to indicate corresponding or analogous elements. The figures are listed below.

FIG. 1 is a schematic block diagram illustration of a system, in accordance with some demonstrative embodiments.

FIGS. 2A, 2B, 2C and 2D are schematic illustrations of four respective connectivity schemes, in accordance with some demonstrative embodiments.

FIG. 3 is a schematic illustration of a frame, in accordance with some demonstrative embodiments.

FIG. 4 is a schematic illustration of a method of establishing an Application Service Platform (ASP) session, in accordance with some demonstrative embodiments.

FIG. 5 is a schematic state diagram illustration of states and operations corresponding to an ASP session via an Access Point (AP), in accordance with some demonstrative embodiments.

FIG. 6 is a schematic state diagram illustration of states and operations at a service seeker, in accordance with some demonstrative embodiments.

FIG. 7 is a schematic state diagram illustration of states and operations at service advertiser, in accordance with some demonstrative embodiments.

FIG. 8 is a schematic illustration of a product of manufacture, in accordance with some demonstrative embodiments.

### DETAILED DESCRIPTION

In the following detailed description, numerous specific details are set forth in order to provide a thorough understanding of some embodiments. However, it will be understood by persons of ordinary skill in the art that some embodiments may be practiced without these specific details. In other instances, well-known methods, procedures, components, units and/or circuits have not been described in detail so as not to obscure the discussion.

Discussions herein utilizing terms such as, for example, “processing”, “computing”, “calculating”, “determining”, “establishing”, “analyzing”, “checking”, or the like, may refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

The terms “plurality” and “a plurality”, as used herein, include, for example, “multiple” or “two or more”. For example, “a plurality of items” includes two or more items.

References to “one embodiment”, “an embodiment”, “demonstrative embodiment”, “various embodiments” etc., indicate that the embodiment(s) so described may include a particular feature, structure, or characteristic, but not every embodiment necessarily includes the particular feature, structure, or characteristic. Further, repeated use of the phrase “in one embodiment” does not necessarily refer to the same embodiment, although it may.

As used herein, unless otherwise specified the use of the ordinal adjectives “first”, “second”, “third” etc., to describe a common object, merely indicate that different instances of like objects are being referred to, and are not intended to imply that the objects so described must be in a given sequence, either temporally, spatially, in ranking, or in any other manner.

The word “demonstrative” is used herein to mean “serving as a demonstration, an example, instance, or illustration”. Any embodiment described herein as “demonstrative” is not necessarily to be construed as preferred or advantageous over other embodiments.

Some embodiments may be used in conjunction with various devices and systems, for example, a User Equipment (UE), a Mobile Device (MD), a wireless Station (STA), a communication station, an access terminal, a communication node, an Access Point (AP), an access node, a Personal Computer (PC), a desktop computer, a mobile computer, a laptop computer, a notebook computer, an Ultrabook™ computer, a tablet computer, a server computer, a handheld computer, a handheld device, a Personal Digital Assistant (PDA) device, a handheld PDA device, a Bluetooth (BT) device, a Bluetooth Low Energy (BLE) device, an on-board device, an off-board device, a hybrid device, a vehicular device, a non-vehicular device, a mobile or portable device, a consumer device, a non-mobile or non-portable device, a wireless communication station, a wireless communication device, a wired or wireless router, a wired or wireless modem, a video device, an audio device, an audio-video (A/V) device, a wired or wireless network, a wireless area network, a Wireless Video Area Network (WVAN), a Local Area Network (LAN), a Wireless LAN (WLAN), a Personal Area Network (PAN), a Wireless PAN (WPAN), and the like.

Some embodiments may be used in conjunction with devices and/or networks operating in accordance with existing IEEE 802.11 standards (IEEE 802.11-2012, IEEE Standard for Information technology—Telecommunications and information exchange between systems Local and metropolitan area networks—Specific requirements Part 11: Wireless LAN Medium Access Control (MAC) and Physical Layer (PHY) Specifications, Mar. 29, 2012; IEEE802.11ac (“IEEE P802.11ac-2013, IEEE Standard for Information Technology—Telecommunications and Information Exchange Between Systems—Local and Metropolitan Area Networks —Specific Requirements—Part 11: Wireless LAN Medium Access Control (MAC) and Physical Layer (PHY) Specifications—Amendment 4: Enhancements for Very High Throughput for Operation in Bands below 6 GHz”, December, 2013”); IEEE 802.11ad (“IEEE P802.11ad-2012, IEEE Standard for Information Technology—Telecommunications and Information Exchange Between Systems—Local and Metropolitan Area Networks—Specific Requirements—Part 11: Wireless LAN Medium Access Control (MAC) and Physical Layer (PHY) Specifications—Amendment 3: Enhancements for Very High Throughput in the 60 GHz Band”, 28 December, 2012); and/or IEEE 802.11ax (High-Efficiency Wi-Fi (HEW)) and/or future versions and/or derivatives thereof, devices and/or networks operating in accordance with existing Wireless-Gigabit-Alliance (WGA) specifications (Wireless Gigabit Alliance, Inc WiGig MAC and PHY Specification Version 1.1, April 2011, Final specification) and/or future versions and/or derivatives thereof, devices and/or networks operating in accordance with existing Wireless Fidelity (WiFi) Alliance (WFA) Peer-to-Peer (P2P) specifications (WiFi P2P technical specification, version 1.2, 2012; and/or WiFi Direct Services (WFDS) 2.0) and/or future versions and/or derivatives thereof, devices and/or networks operating in accordance with existing cellular specifications and/or protocols, e.g., 3rd Generation Partnership Project (3GPP), 3GPP Long Term Evolution (LTE), and/or future versions and/or derivatives thereof, units and/or devices which are part of the above networks, and the like.

Some embodiments may be used in conjunction with one way and/or two-way radio communication systems, multi-radio devices, cellular radio-telephone communication systems, an access terminal, a mobile phone, a cellular telephone, a wireless telephone, a Personal Communication Systems (PCS) device, a PDA device which incorporates a wireless communication device, a mobile or portable Global Positioning System (GPS) device, a device which incorporates a GPS receiver or transceiver or chip, a device which incorporates an RFID element or chip, a Multiple Input Multiple Output (MIMO) transceiver or device, a Single Input Multiple Output (SIMO) transceiver or device, a Multiple Input Single Output (MISO) transceiver or device, a device having one or more internal antennas and/or external antennas, Digital Video Broadcast (DVB) devices or systems, multi-standard radio devices or systems, a wired or wireless handheld device, e.g., a Smartphone, a Wireless Application Protocol (WAP) device, a Mobile Internet Device (MID), or the like.

Some embodiments may be used in conjunction with one or more types of wireless communication signals and/or systems, for example, Radio Frequency (RF), Infra Red (IR), Frequency-Division Multiplexing (FDM), Orthogonal FDM (OFDM), Orthogonal Frequency-Division Multiple Access (OFDMA), Spatial Divisional Multiple Access (SDMA), Multi-User (MU) MIMO (MU-MIMO), Single Carrier Frequency-Division Multiple Access (SC-FDMA), Time-Division Multiplexing (TDM), Time-Division Multiple Access (TDMA), Extended TDMA (E-TDMA), General Packet Radio Service (GPRS), extended GPRS, Code-Division Multiple Access (CDMA), Wideband CDMA (WCDMA), CDMA 2000, single-carrier CDMA, multi-carrier CDMA, Multi-Carrier Modulation (MDM), Discrete Multi-Tone (DMT), Bluetooth®, Global Positioning System (GPS), BT, BLE, Wi-Fi, Wi-Max, ZigBee™, Ultra-Wideband (UWB), Global System for Mobile communication (GSM), 2G, 2.5G, 3G, 3.5G, 4G, Fifth Generation (5G) mobile networks, 3GPP, Long Term Evolution (LTE), LTE advanced, High-Speed Downlink Packet Access (HSDPA), High-Speed Uplink Packet Access (HSUPA), High-Speed Packet Access (HSPA), HSPA+, Single Carrier Radio Transmission Technology (1×RTT), Evolution-Data Optimized (EV-DO), Enhanced Data rates for GSM Evolution (EDGE), and the like. Other embodiments may be used in various other devices, systems and/or networks.

The term “wireless device”, as used herein, includes, for example, a device capable of wireless communication, a communication device capable of wireless communication, a communication station capable of wireless communication, a portable or non-portable device capable of wireless communication, or the like. In some demonstrative embodiments, a wireless device may be or may include a peripheral that is integrated with a computer, or a peripheral that is attached to a computer. In some demonstrative embodiments, the term “wireless device” may optionally include a wireless service.

The term “communicating” as used herein with respect to a wireless communication signal includes transmitting the wireless communication signal and/or receiving the wireless communication signal. For example, a wireless communication unit, which is capable of communicating a wireless communication signal, may include a wireless transmitter to transmit the wireless communication signal to at least one other wireless communication unit, and/or a wireless communication receiver to receive the wireless communication signal from at least one other wireless communication unit. The verb “communicating” may be used to refer to the action of transmitting or the action of receiving. In one example, the phrase “communicating a signal” may refer to the action of transmitting the signal by a first device, and may not necessarily include the action of receiving the signal by a second device. In another example, the phrase “communicating a signal” may refer to the action of receiving the signal by a first device, and may not necessarily include the action of transmitting the signal by a second device.

Some demonstrative embodiments may be used in conjunction with a WLAN, e.g., a Wireless Fidelity (Wi-Fi or WiFi) network, a WFD network, a WFDS network, or a WLAN according to the IEEE 802.11 Standards (also referred to as “the 802.11 network”). Other embodiments may be used in conjunction with any other suitable wireless communication network, for example, a wireless area network, a “piconet”, a WPAN, a WVAN and the like.

The term “antenna”, as used herein, may include any suitable configuration, structure and/or arrangement of one or more antenna elements, components, units, assemblies and/or arrays. In some embodiments, the antenna may implement transmit and receive functionalities using separate transmit and receive antenna elements. In some embodiments, the antenna may implement transmit and receive functionalities using common and/or integrated transmit/receive elements. The antenna may include, for example, a phased array antenna, a single element antenna, a set of switched beam antennas, and/or the like.

The term “station” (STA), as used herein, may include any logical entity that is a singly addressable instance of a medium access control (MAC) and a physical layer (PHY) interface to a wireless medium (WM).

The phrase “access point” (AP), as used herein, may include an entity that contains one station (STA) and provides access to distribution services, via the WM for associated STAs.

The phrase “non-access-point (non-AP) station (STA)”, as used herein, may relate to a STA that is not contained within an AP.

The phrase “peer to peer (PTP or P2P) communication”, as used herein, may relate to device-to-device communication over a wireless link (“peer-to-peer link”) between a pair of devices. The P2P communication may include, for example, wireless communication over a direct link within a QoS basic service set (BSS), a tunneled direct-link setup (TDLS) link, a STA-to-STA communication in an independent basic service set (IBSS), or the like.

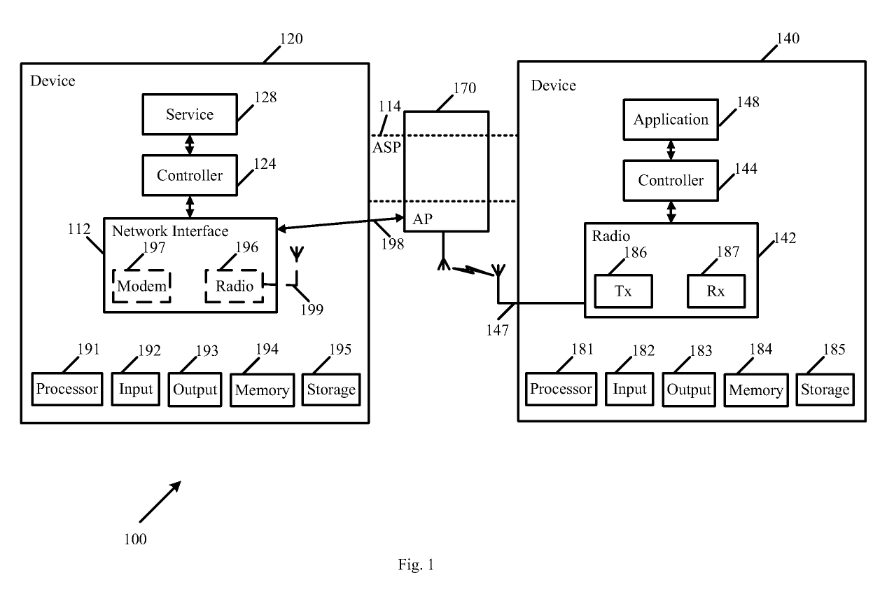

Reference is now made to FIG. 1, which schematically illustrates a block diagram of a system 100 in accordance with some demonstrative embodiments.

In some demonstrative embodiments, system 100 may include one or more non-AP stations, e.g., client STAs, and one or more APs. For example, system may include devices 120 and 140, which may perform the functionality of non-AP stations, and an AP 170, e.g., a WiFi AP, an access node, a base station, a router, and the like.

In some demonstrative embodiments, AP 170 may communicate over a wireless medium, for example, a radio channel, a cellular channel, an RF channel, a WLAN channel, a Wireless Fidelity (WiFi) channel, an IR channel, and the like.

In some demonstrative embodiments, AP 170 may optionally be capable of communicating via one or more wired links and/or networks, e.g., as described below.

In some demonstrative embodiments, at least one of devices 120 and 140 may include a wireless communication device configured to communicate with AP 170 via a wireless communication link, e.g., as described below. One or more elements of system 100 may optionally be capable of communicating over any suitable wired communication links, e.g., as described below.

In one example, both devices 120 and 140 may communicate with AP 170 via wireless links, e.g., as described below.

In another example, one of devices 120 and 140, e.g., device 140 may communicate with AP 170 via a wireless link, and another one of devices 120 and 140, e.g., device 120, may communicate with AP 170 via a wired link, e.g., as described below.

In some demonstrative embodiments, device 120 may include a mobile or a non-mobile device, e.g., a static device. For example, device 120 may include a User Equipment (UE), a Mobile Device (MD), a mobile station, an access terminal, an Internet of Things (IoT) device, a subscriber station, a High Data Rate (HDR) subscriber station, a mobile computer, PC, a desktop computer, a laptop computer, a notebook computer, a tablet computer, a server computer, a handheld computer, an Ultrabook™ computer, a mobile internet device, a handheld device, a source device, a destination device, a PDA device, a handheld PDA device, an on-board device, an off-board device, a hybrid device (e.g., combining cellular phone functionalities with PDA device functionalities), a consumer device, a vehicular device, a non-vehicular device, a mobile or portable device, a non-mobile or non-portable device, a mobile phone, a cellular telephone, a PCS device, a PDA device which incorporates a wireless communication device, a mobile or portable GPS device, a DVB device, a relatively small computing device, a non-desktop computer, a context-aware device, a video device, an audio device, an A/V device, a Set-Top-Box (STB), a video source, an audio source, a video sink, an audio sink, a stereo tuner, a broadcast radio receiver, a flat panel display, a Personal Media Player (PMP), a data source, a data sink, or the like.

In some demonstrative embodiments, device 140 may include, for example, a mobile device. For example, a UE, a MD, a mobile station, an access terminal, an IoT device, a subscriber station, a HDR subscriber station, a mobile computer, a laptop computer, a notebook computer, a tablet computer, an Ultrabook™ computer, a mobile internet device, a handheld computer, a handheld device, a storage device, a PDA device, a handheld PDA device, an on-board device, an off-board device, a hybrid device, a consumer device, a vehicular device, a non-vehicular device, a portable device, a mobile phone, a cellular telephone, a PCS device, a mobile or portable GPS device, a DVB device, a relatively small computing device, a non-desktop computer, a “Carry Small Live Large” (CSLL) device, an Ultra Mobile Device (UMD), an Ultra Mobile PC (UMPC), a Mobile Internet Device (MID), an “Origami” device or computing device, a device that supports Dynamically Composable Computing (DCC), an “Origami” device or computing device, a video device, an audio device, an A/V device, a gaming device, a media player, a Smartphone, or the like.

In some demonstrative embodiments, device 120 may also include, for example, a processor 191, an input unit 192, an output unit 193, a memory unit 194, and/or a storage unit 195; and/or device 140 may also include, for example, a processor 181, an input unit 182, an output unit 183, a memory unit 184, and/or a storage unit 185. Devices 120 and/or 140 may optionally include other suitable hardware components and/or software components. In some demonstrative embodiments, some or all of the components of devices 120 and/or 140 may be enclosed in a common housing or packaging, and may be interconnected or operably associated using one or more wired or wireless links. In other embodiments, components of devices 120 and/or 140 may be distributed among multiple or separate devices.

Processor 191 and/or processor 181 may include, for example, a Central Processing Unit (CPU), a Digital Signal Processor (DSP), one or more processor cores, a single-core processor, a dual-core processor, a multiple-core processor, a microprocessor, a host processor, a controller, a plurality of processors or controllers, a chip, a microchip, one or more circuits, circuitry, a logic unit, an Integrated Circuit (IC), an Application-Specific IC (ASIC), or any other suitable multi-purpose or specific processor or controller. For example, processor 191 executes instructions, for example, of an Operating System (OS) of device 120 and/or of one or more suitable applications; and/or processor 181 executes instructions, for example, of an Operating System (OS) of device 140 and/or of one or more suitable applications.

Memory unit 194 and/or memory unit 184 may include, for example, a Random Access Memory (RAM), a Read Only Memory (ROM), a Dynamic RAM (DRAM), a Synchronous DRAM (SD-RAM), a flash memory, a volatile memory, a non-volatile memory, a cache memory, a buffer, a short term memory unit, a long term memory unit, or other suitable memory units. Storage unit 195 and/or storage unit 185 may include, for example, a hard disk drive, a floppy disk drive, a Compact Disk (CD) drive, a CD-ROM drive, a DVD drive, or other suitable removable or non-removable storage units. For example, memory unit 194 and/or storage unit 195, for example, may store data processed by device 120; and/or memory unit 184 and/or storage unit 185, for example, may store data processed by device 140.

Input unit 192 and/or input unit 182 may include, for example, a keyboard, a keypad, a mouse, a touch-screen, a touch-pad, a track-ball, a stylus, a microphone, or other suitable pointing device or input device. Output unit 193 and/or output unit 183 may include, for example, a monitor, a screen, a touch-screen, a flat panel display, a Light Emitting Diode (LED) display unit, a Liquid Crystal Display (LCD) display unit, a plasma display unit, one or more audio speakers or earphones, or other suitable output devices.

In some demonstrative embodiments, device 140 may include one or more wireless communication units to perform wireless communication between device 140 and AP 170 and/or with one or more other wireless communication devices. For example, device 140 may include at least one radio 142, e.g., including at least one transmitter (Tx) 186, and at least one receiver (Rx) 187. For example, AP 170 may include a WLAN AP, and radio 142 may include a WLAN radio configured to communicate over a WLAN.

In some demonstrative embodiments, transmitter 186, and/or receiver 187 may be configured to communicate wireless communication signals, Radio Frequency (RF) signals, blocks, transmission streams, frames, messages, data items, and/or data. In one example, transmitter 186 and/or receiver 187 may include circuitry, modulation elements, demodulation elements, amplifiers, analog to digital and/or digital to analog converters, filters, RF circuitry, Base Band (BB) circuitry, and/or the like. For example, transmitter 186 and/or receiver 187 may include or may be implemented as part of a transceiver, a wireless Network Interface Card (NIC), and the like.

In some demonstrative embodiments, radio 142 may include, or may be associated with, one or more antennas. For example, radio 142 may be associated with one or more antennas 147, e.g., a single antenna or two or more antennas.

Antennas 147 may include any type of antennas suitable for transmitting and/or receiving wireless communication signals, blocks, transmission streams, frames, messages and/or data. For example, antennas 147 may include any suitable configuration, structure and/or arrangement of one or more antenna elements, components, units, assemblies and/or arrays. Antennas 147 may include, for example, antennas suitable for directional communication, e.g., using beamforming techniques. For example, antennas 147 may include a phased array antenna, a multiple element antenna, a set of switched beam antennas, and/or the like. In some embodiments, antennas 147 may implement transmit and receive functionalities using separate transmit and receive antenna elements. In some embodiments, antennas 147 may implement transmit and receive functionalities using common and/or integrated transmit/receive elements.

In some demonstrative embodiments, device 120 may include a network interface 112 to communicate communication signals, frames, blocks, transmission streams, messages, data items, and/or data with AP 170, e.g., via one or more links 198.

In some demonstrative embodiments, network interface 112 may be configured to communicate with AP 170 via a wireless link. For example, network interface 112 may include at least one radio 196 to communicate wireless communication signals via link 198. For example, radio 196 may include one or more wireless transmitters and/or receivers, e.g., as described above with reference to radio 142. According to these embodiments, network interface 112 may include, or may be associated with, one or more antennas 199.

In some demonstrative embodiments, network interface 112 may be configured to communicate with AP 170 via a wired link. For example, network interface 112 may include at least one radio modulator-demodulator (modem) 197 to communicate communication signals over one or more wired links. For example, modem 197 may include modulation and/or demodulation circuitry to communicate over a wired network, e.g., Ethernet circuitry, Local area Network (LAN) circuitry, and/or any other modem circuitry.

In some demonstrative embodiments, device 120 may be configured to communicate via both wired and wireless links. For example, network interface 112 may include both radio 196 and modem 197. According to these embodiments, device 120 may be able to communicate with one or more devices via one or more wireless links, and to communicate with one or more devices via one or more wired links.

In some demonstrative embodiments, device 120 may be configured to provide one or more services to one or more remote devices, e.g., device 140. For example, device 120 may be configured to provide one or more services 128, e.g., printing services, display services, Internet access services and/or any other services to one or more applications 148 of device 140.

In some demonstrative embodiments, device 120 may be configured to advertize the one or more services, for example, to enable the remote devices to find the services. For example, device 120 may be configured to advertise one or more of the services 128 provided by device 120, e.g., to enable device 140 to discover the services 128 provided by device 120.

In some demonstrative embodiments, device 140 may be configured to utilize the one or more services 128 from device 120. For example, applications 148 may be configured to utilize the services from device 120.

In some demonstrative embodiments, device 140 may be configured to connect to device 120 to receive the services 128 provided by device 120.

In some demonstrative embodiments, device 140 may perform the functionality of a service seeker, and/or device 120 may perform the functionality of a service advertiser. According to these embodiments, device 120 may advertise one or more services 128, which may be provided by device 120, and/or device 140 may discover device 120, e.g., according to a WFDS discovery protocol, or any other protocol.

In some demonstrative embodiments, devices 120 and 140 may establish a P2P connection between devices 120 and 140 to connect between devices 120 and 140, and to provide the one or more services from device 120 to device 140.

In some demonstrative embodiments, the P2P connection may include a wireless P2P connection, e.g., as described below.

In some demonstrative embodiments, the P2P connection may include a direct P2P connection, e.g., a WFD connection, between devices 120 and 140. For example, devices 120 and 140 may establish a direct wireless P2P connection, e.g., via a wireless link between radios 142 and 196.

In some demonstrative embodiments, the P2P connection may include a P2P connection via AP 170, e.g., as described below.

In some demonstrative embodiments, devices 120 and 140 may establish any other connection between devices 120 and 140.

In some demonstrative embodiments, devices 120 and/or 140 may include an Application Service Platform (ASP) configured to manage the procedure of receiving and/or providing the one or more services, e.g., according to a predefined protocol.

In some demonstrative embodiments, device 120 may include an ASP controller 124, and/or device 140 may include an ASP controller 144, configured to manage an ASP-session between devices 120 and 140.

In some demonstrative embodiments, ASP controllers 124 and/or 144 may include or may be implemented using suitable circuitry, e.g., ASP circuitry, memory circuitry, controller circuitry, processor circuitry, and/or any other circuitry, which may be configured to perform at least part of the functionality of ASP controllers 124 and/or 144. Additionally or alternatively, one or more functionalities of ASP controllers 124 and/or 144 may be implemented by logic, which may be executed by a machine and/or one or more processors, e.g., as described below.

In some demonstrative embodiments, ASP controller 124 and/or ASP controller 144 may include a software module and/or a library module that implements functions required for managing the procedure of receiving and/or providing the one or more services. For example, the functions may include discovery of a service, session management, connection topology management, security management and/or any other function to support management of the services.

In some demonstrative embodiments, ASP controller 124 and ASP controller 144 may be configured to establish one or more ASP sessions between devices 120 and 140 over the P2P connection. The ASP session may be utilized, for example, to provide the one or more services between devices 120 and 140.

In some demonstrative embodiments, ASP controller 124 and/or ASP controller 144 may establish the one or more ASP-P2P sessions, for example, via the P2P connection between devices 120 and/or 140.

In some demonstrative embodiments, an ASP-session may include a logical link between ASP controller 124 and ASP controller 144, e.g., over the P2P connection between devices 120 and 140. The ASP session may be configured, for example, to manage the procedure of providing a service between devices 120 and 140.

In some demonstrative embodiments, device 140 may discover one or more devices, e.g., device 120, supporting a service to be utilized by device 140. For example, device 120 may advertize one or more of services 128 supported by device 120, and/or device 140 may discover the services supported by device 120, for example, according to a WFDS discovery protocol, or any other discovery protocol, process, procedure and/or algorithm.

In some demonstrative embodiments, a discovered device, e.g., device 120, may have multiple network interfaces, which may enable the discovered device to be connected to a network via one or more of the interfaces. For example, device 120 may be capable of communicating via a direct wireless link, e.g., a WFD link, as well as via a non-direct link, for example, via an infrastructure link, e.g., via AP 170, as described below.

In some scenarios, it may be preferable to connect to device 120 directly, e.g., via the direct wireless link, while in other scenarios it may be preferable to connect to device 120 via the non-direct link, e.g., via the infrastructure, for example, due to network policy, coverage considerations, performance considerations, and the like.

In some demonstrative embodiments, device 140 may receive connectivity information indicating at least one connectivity scheme to connect to device 120, e.g., as described below.

In some demonstrative embodiments, device 140 may receive the connectivity information during a device discovery procedure for discovering device 120 and/or during a service discovery procedure to discover services 128.

In some demonstrative embodiments, radio 142 may receive a discovery frame, for example, a discovery response frame, e.g., a WFDS discovery response frame, or any other discovery frame, including the connectivity information of device 120.

In some demonstrative embodiments, radio 142 may receive the discovery frame directly from device 120, e.g., during the discovery process.

In some demonstrative embodiments, radio 142 may receive the discovery frame, including the connectivity information of device 120, from another device, e.g., from AP 170 or from another non-AP device. For example, the other device may receive the connectivity information corresponding to device 120, e.g., from device 120 or via one or more other devices, and the other device may include the connectivity information corresponding to device 120 in the discovery frame transmitted by the other device.

In other embodiments, device 140 may receive the connectivity information of device 120 in any other manner. In one example, a user of device 140 may manually enter, e.g., via input unit 182, input information defining the connectivity information of device 120. In another example, the connectivity information of device 120 may be preconfigured in device 140, e.g., by a system administrator, a network operator, and the like.

Some demonstrative embodiments may enable establishing an ASP session between devices 120 and 140 via a connection, which may be established according to one or more connectivity schemes supported by device 120, e.g., as described below.

In some demonstrative embodiments, ASP controller 144 may establish the ASP session between devices 120 and 140 via a network connection supported by device 120, e.g., as described below.

In some demonstrative embodiments, ASP controller 144 may select a connectivity scheme to be used for establishing the ASP session, for example, based on one or more requirements and/or policies of applications 148 and/or services 128. In one example, controller 144 may receive from application 148 an indication of a preferred network connection to be used for establishing the ASP session. For example, one or more applications 148 may prefer using a direct wireless link, while one or more other applications 148 may prefer an indirect link via AP 170. In another example, controller 144 may receive, e.g., as part of the discovery frame, an indication of a preferred network connection, which is preferred by services 128, to be used for establishing the ASP session. In another example, controller 144 may select the network connection based on any other criterion, policy and/or parameter.

In some demonstrative embodiments, device 120 may be configured to support a direct wireless connection, e.g., a WFDS connection, and at least one additional non-direct connectivity scheme, for example, via AP 170, e.g., as described below.

Some demonstrative embodiments may enable devices, e.g., devices 120 and 140, to establish an ASP session via a non-direct connection, e.g., in addition to or instead of establishing the ASP session via a direct wireless connection, e.g., as described below.

In some demonstrative embodiments, devices 120 and 140 may be configured to establish the ASP session via AP 170, e.g., as described below.

In some demonstrative embodiments, the ability to establish the ASP session via AP 170 may enable utilizing one or more connectivity schemes, e.g., in addition to or instead of direct wireless connectivity, to communicate between devices 120 and 140, e.g., as described below.

In some demonstrative embodiments, ASP controllers 124 and/or 144 may be configured to establish an ASP P2P (ASP-P2P) session 114 between devices 120 and 140 via AP 170, e.g., as described below.

In some demonstrative embodiments, ASP controllers 124 and/or 144 may be configured to establish the ASP-P2P session according to at least one connectivity scheme.

In some demonstrative embodiments, the connectivity scheme may include a wired or wireless connectivity between device 120 and AP 170. In one example, network interface 112 may communicate with AP 170 via a wired connection, e.g., using modem 197. In another example, network interface 112 may communicate with AP 170 via a wireless connection, e.g., using radio 196.

In some demonstrative embodiments, the connectivity scheme may include a multi-hop connectivity between the device 120 and AP 170, for example, via at least one other AP, e.g., as described below.

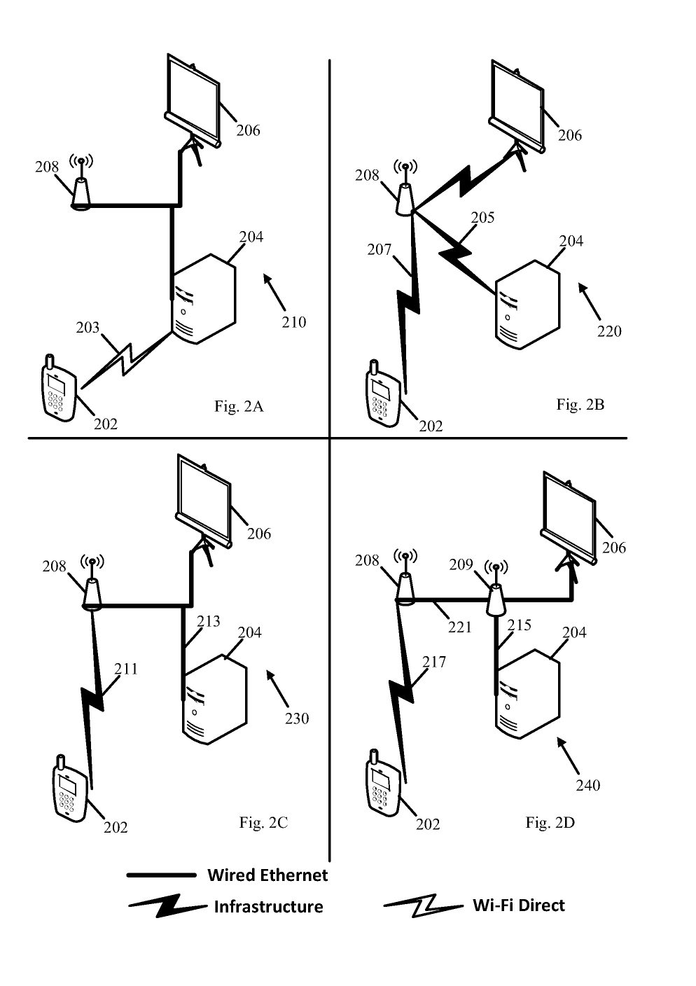

Reference is made to FIGS. 2A, 2B, 2C and 2D, which schematically illustrate four respective connectivity schemes between a computing device 204 and a mobile device 202, in accordance with some demonstrative embodiments. For example, mobile device 202 may perform the functionality of device 140 (FIG. 1), and/or computing device 204 may perform the functionality of device 120 (FIG. 1). In other embodiments, devices 120 and 140 (FIG. 1) may establish an ASP-P2P via any other connectivity scheme.

As shown in FIG. 2A, according to a first connectivity scheme 210, computing device 204 may be capable of connecting to mobile device 202 via a direct wireless link 203, e.g., a WFDS link. As also shown in FIG. 2A, the computing device 204 may be connected to an AP 208, and a screen 206 may be connected to computing device 204 and AP 208 via a wired network, e.g., a LAN.

In some demonstrative embodiments, mobile device 202 may establish an ASP-P2P session with computing device 204 via direct wireless link 203, e.g., using a WFDS connection.

As shown in FIG. 2B, according to a second connectivity scheme 220, computing device 204 may be capable of communicating with mobile device 202 via an infrastructure connection including a wireless link 205 between computing device 204 and AP 208, and a wireless link 207 between AP 208 and mobile device 202. For example, links 205 and/or 207 may include WLAN links, e.g., according to the IEEE 802.11 Standards, and/or any other wireless links.

In some demonstrative embodiments, mobile device 202 may establish an ASP-P2P session with computing device 204 over a P2P link between mobile device 202 and computing device 204, via AP 208, e.g., using links 205 and 207.

As shown in FIG. 2C, according to a third connectivity scheme 230, computing device 204 may be capable of communicating with mobile device 202 via an infrastructure connection including a wired link 213 between computing device 204 and AP 208, and a wireless link 211 between AP 208 and mobile device 202. For example, link 211 may include a WLAN link, e.g., according to the IEEE 802.11 Standards, and/or any other wireless link; and/or link 213 may include a LAN link, e.g., an Ethernet link, or any other wired link.

In some demonstrative embodiments, mobile device 202 may establish an ASP-P2P session with computing device 204 over a P2P link between mobile device 202 and computing device 204, via AP 208, e.g., using links 211 and 213.

As shown in FIG. 2D, according to a fourth connectivity scheme 240, computing device 204 may be capable of communicating with AP 208 using a multi-hop connection via at least one other AP 209. For example, computing device 204 may be capable of communicating with mobile device 202 via an infrastructure connection including a wired link 215 between computing device 204 and AP 209, a wired link 221 between AP 209 and AP 208, and a wireless link 217 between AP 208 and mobile device 202.

In some demonstrative embodiments, mobile device 202 may establish an ASP-P2P session with computing device 204 over a P2P link between mobile device 202 and computing device 204, via APs 208 and 209, e.g., using links 217, 221 and 215.

Referring back to FIG. 1, controller 144 may receive connectivity information indicating at least one connectivity scheme to connect to device 120, and may establish the ASP-P2P session 114 based on the connectivity information.

In some demonstrative embodiments, controller 144 may receive the connectivity information in a discovery frame from device 120. For example, controller 124 may send a device discovery frame or a service discovery frame including the connectivity information corresponding to device 120.

In some demonstrative embodiments, the connectivity information may include a list of network interfaces, via which device 120 may be connected to.

In some demonstrative embodiments, the connectivity information may indicate at least one of connectivity schemes 210, 220, 230 and 240 (FIGS. 2A-2D).

In one example, the connectivity information may indicate that device 120 may be connected to via a WFD connection, e.g., according to connectivity scheme 210 (FIG. 2A), as well as via at least one infrastructure connection via AP 170, e.g., according to connectivity scheme 220 (FIG. 2B), connectivity scheme 230 (FIG. 2C), and/or connectivity scheme 240 (FIG. 2D).

In some demonstrative embodiments, controller 144 may select to establish an ASP-P2P session with device 120 via a WFD link, e.g., if selecting to use connectivity scheme 210 (FIG. 2A).

In some demonstrative embodiments, controller 144 may select to establish ASP-P2P session 114 with device 120 via AP 170, e.g., if selecting to use connectivity scheme 220 (FIG. 2B), 230 (FIG. 2C), or 240 (FIG. 2D).

In some demonstrative embodiments, devices 120 and 140 may communicate frames of the ASP-P2P session 114 via AP 170. For example, radio 142 may communicate a frame of the ASP-P2P session 114 with device 120 via AP 170, and network interface 112 may communicate the frame of the ASP-P2P session 114 with device 140 via AP 170, as described below.

In some demonstrative embodiments, the connectivity information corresponding to device 120 may include an identifier of AP 170, e.g., to indicate to device 140, that AP 170 is to be used to establish the ASP-P2P session 114.

In some demonstrative embodiments, device 140 may be associated with AP 170, e.g., prior to discovering device 120. According to these embodiments, controller 144 may establish the ASP-P2P session 114 with device 120, e.g., using the association with AP 170.

In some demonstrative embodiments, device 140 may not be associated with AP 170, e.g., prior to discovering device 120. According to these embodiments, controller 144 may associate with AP 170, e.g., based on the identifier of AP 170.

In some demonstrative embodiments, controller 124 may establish the ASP-P2P session 114 with device 140, for example, subsequent to receipt of an indication that device 140 is associated with AP 170.

In some demonstrative embodiments, device 140 may send to device 120 at least one ASP message, e.g., an ASP Version message or any other message, to indicate that device 140 is associated with AP 170. For example, device 140 may send the ASP Version message to device 120 via AP 170. Accordingly, successful receipt of the ASP Version message at device 120 may indicate to device 120 that device 140 is successfully associated with AP 170.

In some demonstrative embodiments, the identifier of AP 170 may include a Basic Service Set Identification (BSSID) of AP 170. For example, the connectivity information corresponding to device 120 may include the BSSID of AP 170. In one example, device 120 may send a discovery frame, e.g., a WFDS discovery response frame, including the connectivity information of device 120, which may include the BSSID of AP 170.

In other embodiments, the identifier of AP 170 may include any other identifier, e.g., a Media Access Control (MAC) address, a Service Set Identifier (SSID), or the like.

In some demonstrative embodiments, a frame communicated between devices 120 and 140 via AP 170 may include an address of device 120, an address of device 140 device, and an identifier of AP 170, e.g., as described below.

In some demonstrative embodiments, the frame may include an AP-session establishment frame to establish the ASP-P2P session 114.

In some demonstrative embodiments, the frame may include an AP-session frame communicated during the ASP-P2P session 114.

In some demonstrative embodiments, the frame may include a first address field including an address, e.g., a MAC address, of a sender of the frame, e.g., a MAC address of one of devices 120 and 140, a second address field including an address, e.g., a MAC address, of a destination of the frame, e.g., a MAC address of another one of devices 120 and 140, and the identifier of AP 170, e.g., to enable AP 170 to forward the frame to the destination.

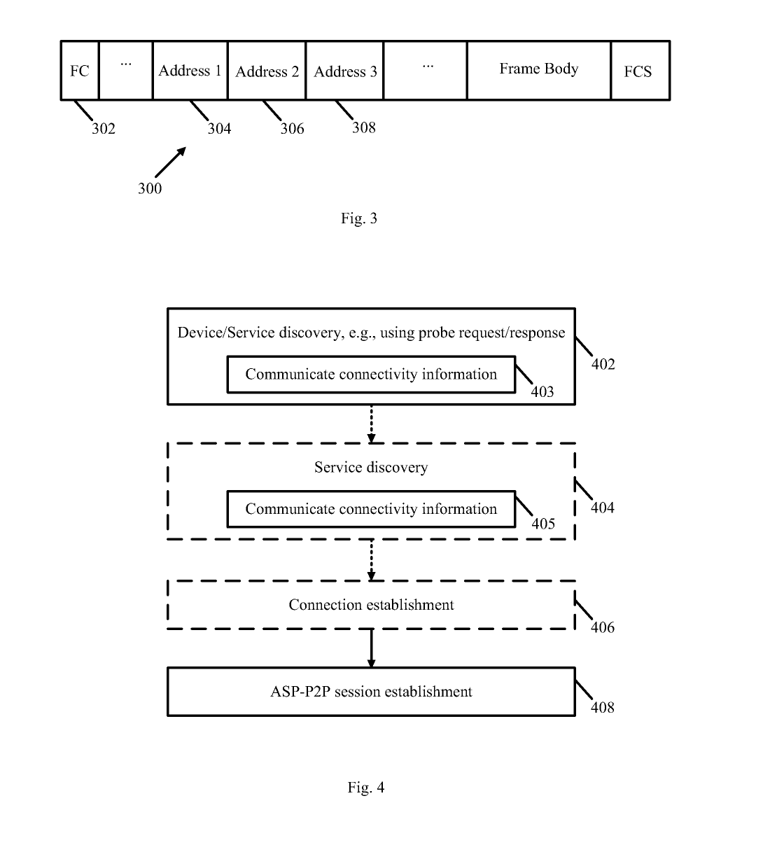

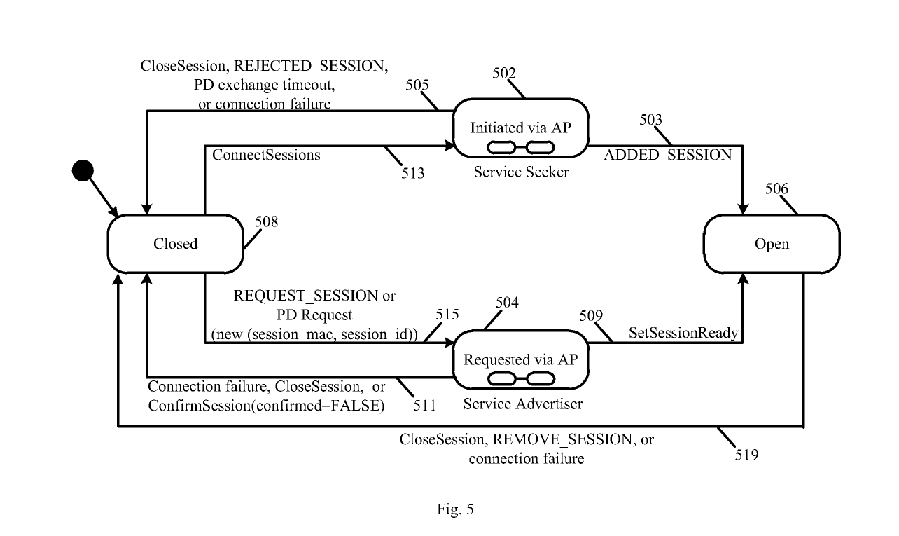

Reference is made to FIG. 3, which schematically illustrates a frame 300, in accordance with some demonstrative embodiments. For example, frame 300 may be communicated between devices 120 and 140, via AP 170 (FIG. 1).

In some demonstrative embodiments, frame 300 may include a frame control field 302 to indicate a type and/or directionality of frame 300. For example, frame control field 302 may include a first bit, denoted to Destination Station (DS), and a second bit, denoted from DS, e.g., as described below.

In some demonstrative embodiments, frame 300 may include a first address field 304, denoted Address1, a second address field 306, denoted Address2, and a third address field 308, denoted Address3.

In some demonstrative embodiments, the contents of fields 302, 304, 306 and 308 may be set, for example, by a sender of frame 300, e.g., to enable AP 170 (FIG. 1) to communicate frame 300 between devices 120 and 140 (FIG. 1).

In one example, frame 300 may be communicated between a service seeker, e.g., device 140 (FIG. 1), and a service advertiser, e.g., device 120 (FIG. 1), via an AP, e.g., AP 170 (FIG. 1), and the contents of fields 302, 304, 306 and 308 of frame 300 may be set, e.g., as follows:

TABLE 1

| Frame type/ | To | From | | | |
|---|---|---|---|---|---|
| directionality | DS | DS | Address 1 | Address2 | Address3 |
| Sent from | 1 | 0 | BSSID of AP | Seeker | Advertiser |
| Seeker to | | | | MAC | MAC |
| Advertiser | | | | Address | address |
| via AP | | | | | |
| From AP to | 0 | 1 | Advertiser/ | BSSID of | Seeker/ |
| Seeker/ | | | Seeker | AP | Advertiser |
| Advertiser | | | MAC address | | MAC Address |
| Sent from | 1 | 0 | BSSID of AP | Advertiser | Seeker |
| Advertiser to | | | | MAC | MAC |
| Seeker via AP | | | | address | address |

In one example, device 140 (FIG. 1) may send frame 300 to device 120 (FIG. 1) via AP 170 (FIG. 1). According to this example, field 302 may include the two-bit value “10”, field 304 may include the BSSID of AP 170 (FIG. 1), field 306 may include the MAC address of device 140 (FIG. 1), and field 308 may include the MAC address of device 120 (FIG. 1).

Reference is made to FIG. 4, which illustrates a method of establishing an ASP session, in accordance with some demonstrative embodiments. In some demonstrative embodiments, one or more of the operations of the method of FIG. 4 may be performed by one or more elements of a system, e.g., system 100 (FIG. 1), for example, a device, e.g., device 120 and/or device 140 (FIG. 1).

As indicated at block 402, the method may include discovering a device and/or a service, e.g., according to a device/service discovery process. For example, devices 120 and 140 (FIG. 1) may exchange a probe request and/or probe response to enable device 140 (FIG. 1) to discover device 120 (FIG. 1), e.g., according to a WFDS discovery process.

As indicated at block 404, the method may optionally include communicating one or more service discovery messages, for example, to provide a service seeker with information about one or more services offered by a service advertiser. For example, the service discovery messages may be communicated, e.g., in order to provide additional information, which is not communicated during the device/discovery process.

In some demonstrative embodiments, the method may include communicating connectivity information corresponding to the service advertiser as part of the messages of the device/service discovery process, as indicated at block 403, and/or as part of the service discovery messages, as indicated at block 405. The connectivity information may identify an AP to be used to establish a connection with the service advertiser, e.g., as described above. For example, device 120 (FIG. 1) may send one or more device frames and/or service discovery frames, e.g., response frames, including the connectivity information corresponding to device 120 (FIG. 1).

As indicated at block 406, the method may optionally include establishing a P2P connection via the AP. For example, device 140 (FIG. 1) my establish a P2P connection with device 120 (FIG. 1) via AP 170, e.g., based on a BSSID of AP 170 (FIG. 1), which may be included in the connectivity information, e.g., as described above.

As indicated at block 408, the method may include establishing an ASP-P2P session via the P2P connection. For example, ASP controllers 124 and 144 (FIG. 1) may establish ASP-P2P session 114 (FIG. 1) via AP 170 (FIG. 1), e.g., as described above.

In some demonstrative embodiments, the method may include communicating one or more frames of the ASP-P2P session via the AP. For example, devices 120 and 140 (FIG. 1) may communicate via AP 170 (FIG. 1) one or more frames for establishing the ASP-P2P session, and/or one or more frames during the ASP-P2P session.

Reference is made to FIG. 5, which schematically illustrates a state diagram of operations and states corresponding to an ASP-P2P session via an AP, in accordance with some demonstrative embodiments. In some demonstrative embodiments, one or more of the operations of FIG. 5 may be performed by one or more elements of a system, e.g., system 100 (FIG. 1), for example, a service advertiser, e.g., device 120 (FIG. 1), and/or a service seeker, e.g., device 140 (FIG. 1).

In some demonstrative embodiments, a service seeker, e.g., device 140 (FIG. 1), may operate at an initiated state 502 (“initiated via AP”), and a service advertiser, e.g., device 120 (FIG. 1), may operate at a requested state 504 (“Requested via AP”), to switch between an open state 506, when an ASP-P2P session via an AP, e.g., AP 170 (FIG. 1), is open, and a closed state 508, when the ASP-P2P session is closed, e.g., as described below.

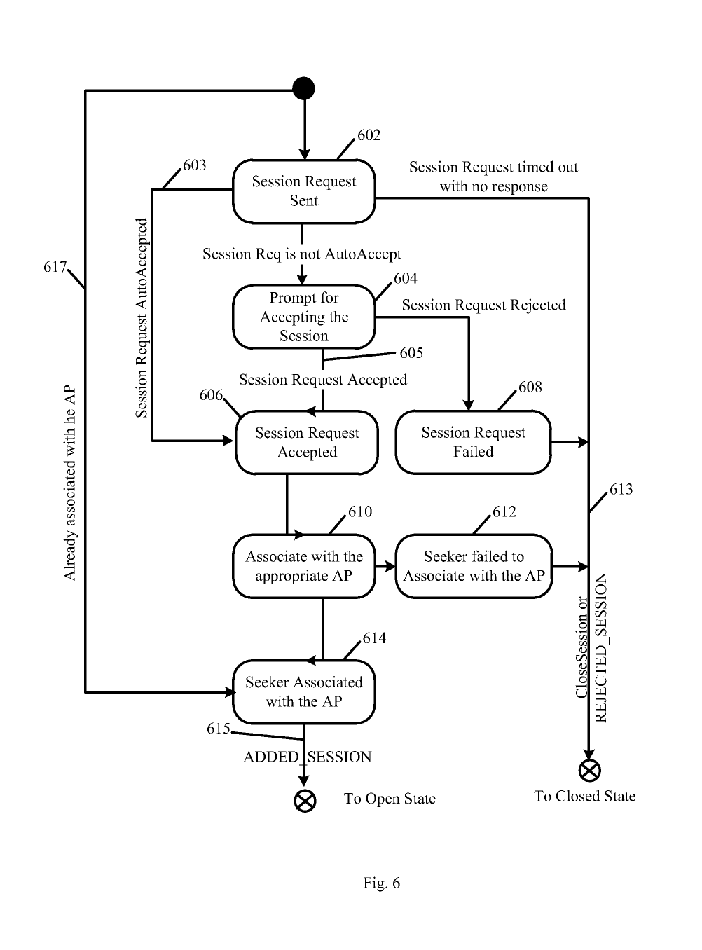

In some demonstrative embodiments, initiated state 502 may include one or more states and operations to be performed by the service seeker to establish the ASP-P2P session via the AP, e.g., as described below with respect to FIG. 6.

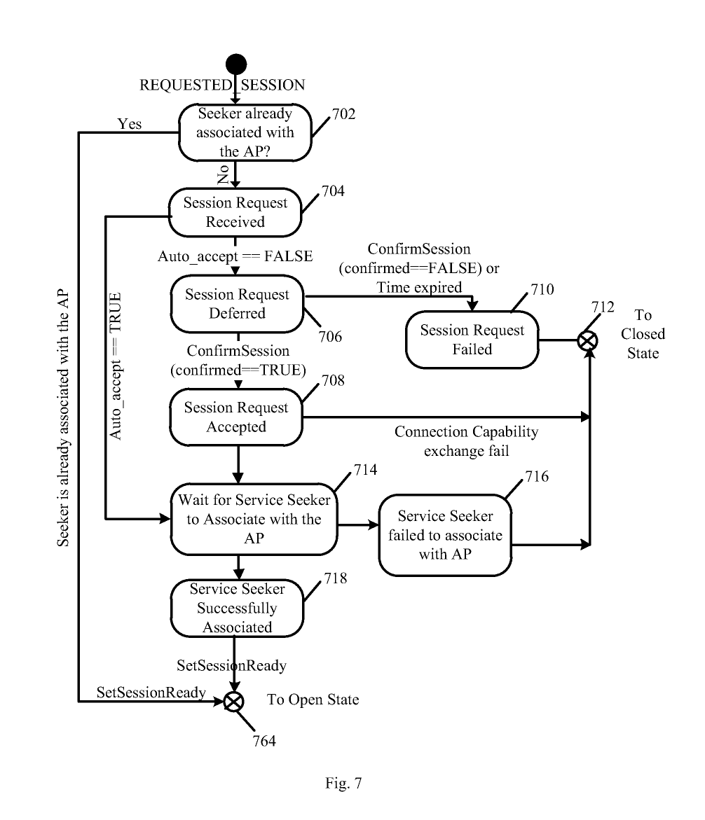

In some demonstrative embodiments, requested state 504 may include one or more states and operations to be performed by the service advertiser to establish the ASP-P2P session via the AP, e.g., as described below with respect to FIG. 7.

In some demonstrative embodiments, the service seeker may switch to the open state 506, for example, upon an added session command, as indicated by arrow 503.

In some demonstrative embodiments, the service seeker may switch to the closed state 508, for example, upon determining to close or reject the ASP-P2P session, or upon failure to establish the ASP-P2P session, as indicated by arrow 505.

In some demonstrative embodiments, the service advertiser may switch to the open state 506, for example, upon successfully setting up the ASP-P2P session, as indicated by arrow 509.

In some demonstrative embodiments, the service advertiser may switch to the closed state 508, for example, upon determining to close the ASP-P2P session or upon failure to establish the ASP-P2P session, as indicated by arrow 511.

In some demonstrative embodiments, the service seeker may switch from the closed state 508 to the initiated state 502, and the service advertiser may switch from the closed state 508 to the requested state 504,for example, upon a request to connect to a service provided by the service advertiser, as indicated by arrows 513 and 515.

In some demonstrative embodiments, the service seeker and the service advertiser may switch from the open state 506 to the closed state 508, for example, to close the ASP-P2P session, e.g., as indicated by arrow 519.

Reference is made to FIG. 6, which schematically illustrates state diagram of operations and states at a service seeker, in accordance with some demonstrative embodiments. For example, one or more of the states and operations of FIG. 6 may be performed by a service seeker, e.g., device 140 (FIG. 1), at an initiated state, e.g., initiated state 502 (FIG. 5).

In some demonstrative embodiments, the service seeker may operate at one or more states to request to establish the ASP-P2P session with the service advertiser. For example, the service seeker may operate at a session request state 602 to request establishing the ASP-P2P session. The service seeker may switch to a session request accepted state 606, for example, if the request is auto accepted by the service advertiser, as indicated by arrow 603; or after prompting the service advertiser, as indicated at block 604, and receiving an indication from the service advertiser that the session request is accepted, as indicated by arrow 605. The service seeker may switch to a session request failed state 608, for example, if the session request is rejected.

In some demonstrative embodiments, the service seeker may associate with an AP via which the ASP-P2P session is to be established, as indicated at block 610, e.g., if the session request is accepted. For example, device 140 (FIG. 1) may establish a connection with AP 170 (FIG. 1), for example, based on the connectivity information of device 120 (FIG. 1), e.g., as described above.

In some demonstrative embodiments, the service seeker may fail to establish the connection to the AP, as indicated at block 612.

In some demonstrative embodiments, the initiated state may terminate with a close session command or a reject session command, as indicated by arrow 613, for example, if the session request is rejected, no response is received to the session request and a timeout is reached, or if association with the AP fails.

In some demonstrative embodiments, the service seeker may be associated with the AP, as indicated at block 614, for example, if association with the AP is successful.

In some demonstrative embodiments, the service seeker may switch directly to the associated state of block 614, for example, if the service seeker is already associated with the AP, as indicated by arrow 617.

In some demonstrative embodiments, the initiated state may terminate with an added session command, as indicated by arrow 615, for example, if the service seeker is successfully associated with the AP.

Reference is made to FIG. 7, which schematically illustrates state diagram of states and operations at a service advertiser, in accordance with some demonstrative embodiments. For example, one or more of the states and operations of FIG. 7 may be performed by a service advertiser, e.g., device 120 (FIG. 1), at a requested state, e.g., requested state 504 (FIG. 5).

In some demonstrative embodiments, the service advertiser may determine whether the service seeker is already associated with the AP, via which an ASP-P2P session is to be established, as indicated at block 702.

In some demonstrative embodiments, the service seeker may indicate to the service advertiser whether or not the service seeker is associated with the AP.

In some demonstrative embodiments, the service seeker may send to the service advertiser an ASP Version message to indicate that the service seeker has a connection established with the AP. In other embodiments, the service seeker may send to the service advertiser any other message to indicate that the service seeker has a connection established with the AP.

In some demonstrative embodiments, the service advertiser may switch to a Session Request Received state 704, for example, if the service seeker does not have a connection established with the AP.

In some demonstrative embodiments, the service advertiser may switch to a session request deferred state 706, for example, if the session request is not automatically accepted.

In some demonstrative embodiments, the service advertiser may switch to a session request accepted state 708, for example, if the session request is accepted.

In some demonstrative embodiments, the service advertiser may switch to a session request failed state 710, for example, if the session request is rejected, or if the session request is not accepted and a timeout is reached.

In some demonstrative embodiments, the service advertiser may switch to a waiting state 714 to wait to receive from the service seeker an indication that the service seeker established a connection with the AP, for example, if the session request is auto-accepted at state 704, or if the session request is accepted at state 708.

In some demonstrative embodiments, the service advertiser may determine that the service seeker failed to establish a connection with the AP (state 716), or that the service seeker successfully established a connection with the AP (state 718).

In some demonstrative embodiments, the service advertiser may switch to the session close state 712, e.g., closed state 508 (FIG. 5), for example, if the session request was rejected, if the session request was accepted and a connection capability exchange failed, or if the service seeker failed to associate with the AP.

In some demonstrative embodiments, the service advertiser may switch to the session open state 764, e.g., open state 506 (FIG. 5), for example, if the service seeker is associated with the AP.

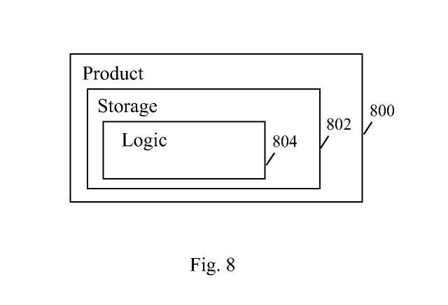

Reference is made to FIG. 8, which schematically illustrates a product of manufacture 800, in accordance with some demonstrative embodiments. Product 800 may include a non-transitory machine-readable storage medium 802 to store logic 804, which may be used, for example, to perform at least part of the functionality of device 120 (FIG. 1), device 140 (FIG. 1), controller 124 (FIG. 1), and/or controller 144 (FIG. 1), to perform one or more of the operations of the method of FIG. 4, and/or to perform one or more operations of the state diagrams of FIGS. 5, 6, and/or 7. The phrase “non-transitory machine-readable medium” is directed to include all computer-readable media, with the sole exception being a transitory propagating signal.

In some demonstrative embodiments, product 800 and/or machine-readable storage medium 802 may include one or more types of computer-readable storage media capable of storing data, including volatile memory, non-volatile memory, removable or non-removable memory, erasable or non-erasable memory, writeable or re-writeable memory, and the like. For example, machine-readable storage medium 802 may include, RAM, DRAM, Double-Data-Rate DRAM (DDR-DRAM), SDRAM, static RAM (SRAM), ROM, programmable ROM (PROM), erasable programmable ROM (EPROM), electrically erasable programmable ROM (EEPROM), Compact Disk ROM (CD-ROM), Compact Disk Recordable (CD-R), Compact Disk Rewriteable (CD-RW), flash memory (e.g., NOR or NAND flash memory), content addressable memory (CAM), polymer memory, phase-change memory, ferroelectric memory, silicon-oxide-nitride-oxide-silicon (SONOS) memory, a disk, a floppy disk, a hard drive, an optical disk, a magnetic disk, a card, a magnetic card, an optical card, a tape, a cassette, and the like. The computer-readable storage media may include any suitable media involved with downloading or transferring a computer program from a remote computer to a requesting computer carried by data signals embodied in a carrier wave or other propagation medium through a communication link, e.g., a modem, radio or network connection.

In some demonstrative embodiments, logic 804 may include instructions, data, and/or code, which, if executed by a machine, may cause the machine to perform a method, process and/or operations as described herein. The machine may include, for example, any suitable processing platform, computing platform, computing device, processing device, computing system, processing system, computer, processor, or the like, and may be implemented using any suitable combination of hardware, software, firmware, and the like.

In some demonstrative embodiments, logic 804 may include, or may be implemented as, software, a software module, an application, a program, a subroutine, instructions, an instruction set, computing code, words, values, symbols, and the like. The instructions may include any suitable type of code, such as source code, compiled code, interpreted code, executable code, static code, dynamic code, and the like. The instructions may be implemented according to a predefined computer language, manner or syntax, for instructing a processor to perform a certain function. The instructions may be implemented using any suitable high-level, low-level, object-oriented, visual, compiled and/or interpreted programming language, such as C, C++, Java, BASIC, Matlab, Pascal, Visual BASIC, assembly language, machine code, and the like.

### EXAMPLES

The following examples pertain to further embodiments.

Example 1 includes a first device comprising a radio to communicate over a Wireless Local Area Network (WLAN); and a controller to establish an Application Service Platform (ASP) Peer-to-Peer (P2P) (ASP-P2P) session between the first device and a second device via a WLAN Access Point (AP), the radio to communicate at least one frame with the second device via the WLAN AP, the frame including an address of the first device, an address of the second device, and an identifier of the WLAN AP.

Example 2 includes the subject matter of Example 1, and optionally, wherein the controller is to receive connectivity information indicating at least one connectivity scheme to connect to the second device, and to establish the ASP-P2P session based on the connectivity information.

Example 3 includes the subject matter of Example 2, and optionally, wherein the radio is to receive a discovery response frame including the connectivity information.

Example 4 includes the subject matter of Example 3, and optionally, wherein the radio is to receive the discovery response frame from the second device.

Example 5 includes the subject matter of any one of Examples 2-4, and optionally, wherein the connectivity information includes the identifier of the WLAN AP, the controller to associate with the WLAN AP based on the identifier of the WLAN AP.

Example 6 includes the subject matter of any one of Examples 2-5, and optionally, wherein the connectivity scheme includes a wired or wireless connectivity between the second device and the WLAN AP.

Example 7 includes the subject matter of any one of Examples 2-6, and optionally, wherein the connectivity scheme includes a multi-hop connectivity between the second device and the WLAN AP via at least one other AP.

Example 8 includes the subject matter of any one of Examples 2-7 being a service seeker.

Example 9 includes the subject matter of Example 1 being a service advertiser, the controller to establish the ASP-P2P session subsequent to receipt of an indication that the second device is associated with the WLAN AP.

Example 10 includes the subject matter of any one of Examples 1-9, and optionally, wherein the at least one frame comprises at least one ASP session establishment frame to establish the ASP-P2P session.

Example 11 includes the subject matter of any one of Examples 1-10, and optionally, wherein the identifier of the WLAN AP comprises a Basic Service Set Identification (BSSID).

Example 12 includes the subject matter of any one of Examples 1-10, and optionally, wherein the ASP-P2P session comprises a Wireless-Fidelity (Wi-Fi) Direct (WFD) session.

Example 13 includes the subject matter of any one of Examples 1-12 being a mobile device including one or more antennas, a processor, and a memory.

Example 14 includes a wireless communication system including a first device, the first device comprising one or more antennas; a memory; a processor; a radio to communicate over a Wireless Local Area Network (WLAN); and a controller to establish an Application Service Platform (ASP) Peer-to-Peer (P2P) (ASP-P2P) session between the first device and a second device via a WLAN Access Point (AP), the radio to communicate with the second device at least one frame of the ASP-P2P session, the frame including an address of the first device, an address of the second device and an identifier of the WLAN AP.

Example 15 includes the subject matter of Example 14, and optionally, wherein the controller is to receive connectivity information indicating at least one connectivity scheme to connect to the second device, and to establish the ASP-P2P session based on the connectivity information.

Example 16 includes the subject matter of Example 15, and optionally, wherein the radio is to receive a discovery response frame including the connectivity information.

Example 17 includes the subject matter of Example 16, and optionally, wherein the radio is to receive the discovery response frame from the second device.

Example 18 includes the subject matter of any one of Examples 15-17, and optionally, wherein the connectivity information includes the identifier of the WLAN AP, the controller to associate with the WLAN AP based on the identifier of the WLAN AP.

Example 19 includes the subject matter of any one of Examples 15-18, and optionally, wherein the connectivity scheme includes a wired or wireless connectivity between the second device and the WLAN AP.

Example 20 includes the subject matter of any one of Examples 15-19, and optionally, wherein the connectivity scheme includes a multi-hop connectivity between the second device and the WLAN AP via at least one other AP.

Example 21 includes the subject matter of any one of Examples 15-20, and optionally, wherein the first device is a service seeker.

Example 22 includes the subject matter of Example 14 being a service advertiser, the controller to establish the ASP-P2P session subsequent to receipt of an indication that the second device is associated with the WLAN AP.

Example 23 includes the subject matter of any one of Examples 14-22, and optionally, wherein the at least one frame comprises at least one ASP session establishment frame to establish the ASP-P2P session.

Example 24 includes the subject matter of any one of Examples 14-23, and optionally, wherein the identifier of the WLAN AP comprises a Basic Service Set Identification (BSSID).

Example 25 includes the subject matter of any one of Examples 14-24, and optionally, wherein the ASP-P2P session comprises a Wireless-Fidelity (Wi-Fi) Direct (WFD) session.

Example 26 includes the subject matter of any one of Examples 14-25, and optionally, wherein the first device is a mobile device.

Example 27 includes a method performed by a first device, the method comprising establishing an Application Service Platform (ASP) Peer-to-Peer (P2P) (ASP-P2P) session between the first device and a second device via a WLAN Access Point (AP); and communicating with the second device at least one frame of the ASP-P2P session, the frame including an address of the first device, an address of the second device and an identifier of the WLAN AP.

Example 28 includes the subject matter of Example 27, and optionally, comprising receiving connectivity information indicating at least one connectivity scheme to connect to the second device, and establishing the ASP-P2P session based on the connectivity information.

Example 29 includes the subject matter of Example 28, and optionally, comprising receiving a discovery response frame including the connectivity information.

Example 30 includes the subject matter of Example 29, and optionally, comprising receiving the discovery response frame from the second device.

Example 31 includes the subject matter of any one of Examples 28-30, and optionally, wherein the connectivity information includes the identifier of the WLAN AP, the method comprising associating with the WLAN AP based on the identifier of the WLAN AP.

Example 32 includes the subject matter of any one of Examples 28-31, and optionally, wherein the connectivity scheme includes a wired or wireless connectivity between the second device and the WLAN AP.

Example 33 includes the subject matter of any one of Examples 28-32, and optionally, wherein the connectivity scheme includes a multi-hop connectivity between the second device and the WLAN AP via at least one other AP.

Example 34 includes the subject matter of any one of Examples 28-33, and optionally, wherein the first device is a service seeker.

Example 35 includes the subject matter of Example 27, and optionally, wherein the first device is a service advertiser, the method comprising establishing the ASP-P2P session subsequent to receipt of an indication that the second device is associated with the WLAN AP.

Example 36 includes the subject matter of any one of Examples 27-35, and optionally, wherein the at least one frame comprises at least one ASP session establishment frame to establish the ASP-P2P session.

Example 37 includes the subject matter of any one of Examples 27-36, and optionally, wherein the identifier of the WLAN AP comprises a Basic Service Set Identification (BSSID).

Example 38 includes the subject matter of any one of Examples 27-37, and optionally, wherein the ASP-P2P session comprises a Wireless-Fidelity (Wi-Fi) Direct (WFD) session.

Example 39 includes a product including one or more tangible computer-readable non-transitory storage media comprising computer-executable instructions operable to, when executed by at least one computer processor, enable the at least one computer processor to implement a method a first device, the method comprising establishing an Application Service Platform (ASP) Peer-to-Peer (P2P) (ASP-P2P) session between the first device and a second device via a WLAN Access Point (AP); and communicating with the second device at least one frame of the ASP-P2P session, the frame including an address of the first device, an address of the second device and an identifier of the WLAN AP.

Example 40 includes the subject matter of Example 39, and optionally, wherein the method comprises receiving connectivity information indicating at least one connectivity scheme to connect to the second device, and establishing the ASP-P2P session based on the connectivity information.

Example 41 includes the subject matter of Example 40, and optionally, wherein the method comprises receiving a discovery response frame including the connectivity information.

Example 42 includes the subject matter of Example 41, and optionally, wherein the method comprises receiving the discovery response frame from the second device.

Example 43 includes the subject matter of any one of Examples 40-42, and optionally, wherein the connectivity information includes the identifier of the WLAN AP, the method comprising associating with the WLAN AP based on the identifier of the WLAN AP.

Example 44 includes the subject matter of any one of Examples 40-43, and optionally, wherein the connectivity scheme includes a wired or wireless connectivity between the second device and the WLAN AP.

Example 45 includes the subject matter of any one of Examples 40-44, and optionally, wherein the connectivity scheme includes a multi-hop connectivity between the second device and the WLAN AP via at least one other AP.

Example 46 includes the subject matter of any one of Examples 40-45, and optionally, wherein the first device is a service seeker.

Example 47 includes the subject matter of Example 39, and optionally, wherein the first device is a service advertiser, the method comprising establishing the ASP-P2P session subsequent to receipt of an indication that the second device is associated with the WLAN AP.

Example 48 includes the subject matter of any one of Examples 39-47, and optionally, wherein the at least one frame comprises at least one ASP session establishment frame to establish the ASP-P2P session.

Example 49 includes the subject matter of any one of Examples 39-48, and optionally, wherein the identifier of the WLAN AP comprises a Basic Service Set Identification (BSSID).

Example 50 includes the subject matter of any one of Examples 39-49, and optionally, wherein the ASP-P2P session comprises a Wireless-Fidelity (Wi-Fi) Direct (WFD) session.

Example 51 includes a first device comprising a network interface to communicate with a Wireless Local Area Network (WLAN) Access point (AP); and a controller to establish an Application Service Platform (ASP) Peer-to-Peer (P2P) (ASP-P2P) session between the first device and a second device via the WLAN AP, the network interface to communicate at least one frame with the second device via the WLAN AP, the frame including an address of the first device, an address of the second device, and an identifier of the WLAN AP.

Example 52 includes the subject matter of Example 51, and optionally, wherein the controller is to send to the second device connectivity information indicating at least one connectivity scheme to connect to the first device.

Example 53 includes the subject matter of Example 52, and optionally, wherein the network interface is to send a discovery frame including the connectivity information.

Example 54 includes the subject matter of Example 52 or 53, and optionally, wherein the connectivity information includes the identifier of the WLAN AP.

Example 55 includes the subject matter of any one of Examples 52-54, and optionally, wherein the connectivity scheme includes a wired or wireless connectivity between the first device and the WLAN AP.

Example 56 includes the subject matter of any one of Examples 52-55, and optionally, wherein the connectivity scheme includes a multi-hop connectivity between the first device and the WLAN AP via at least one other AP.

Example 57 includes the subject matter of any one of Examples 51-56, and optionally, wherein the controller to establish the ASP-P2P session subsequent to receipt of an indication that the second device is associated with the WLAN AP.

Example 58 includes the subject matter of any one of Examples 51-57 being a service advertiser.

Example 59 includes the subject matter of any one of Examples 51-58, and optionally, wherein the at least one frame comprises at least one ASP session establishment frame to establish the ASP-P2P session.

Example 60 includes the subject matter of any one of Examples 51-59, and optionally, wherein the identifier of the WLAN AP comprises a Basic Service Set Identification (BSSID).

Example 61 includes the subject matter of any one of Examples 51-60, and optionally, wherein the ASP-P2P session comprises a Wireless-Fidelity (Wi-Fi) Direct (WFD) session.

Example 62 includes the subject matter of any one of Examples 51-61, and optionally, wherein the network interface is to communicate with the WLAN AP via a wired or wireless link.

Example 63 includes a communication system including a first device, the first device comprising a memory; a processor; a network interface to communicate with a Wireless Local Area Network (WLAN) Access point (AP); and a controller to establish an Application Service Platform (ASP) Peer-to-Peer (P2P) (ASP-P2P) session between the first device and a second device via the WLAN AP, the network interface to communicate at least one frame with the second device via the WLAN AP, the frame including an address of the first device, an address of the second device, and an identifier of the WLAN AP.

Example 64 includes the subject matter of Example 63, and optionally, wherein the controller is to send to the second device connectivity information indicating at least one connectivity scheme to connect to the first device.

Example 65 includes the subject matter of Example 64, and optionally, wherein the network interface is to send a discovery frame including the connectivity information.

Example 66 includes the subject matter of Example 64 or 65, and optionally, wherein the connectivity information includes the identifier of the WLAN AP.

Example 67 includes the subject matter of any one of Examples 64-66, and optionally, wherein the connectivity scheme includes a wired or wireless connectivity between the first device and the WLAN AP.

Example 68 includes the subject matter of any one of Examples 64-66, and optionally, wherein the connectivity scheme includes a multi-hop connectivity between the first device and the WLAN AP via at least one other AP.

Example 69 includes the subject matter of any one of Examples 63-68, and optionally, wherein the controller to establish the ASP-P2P session subsequent to receipt of an indication that the second device is associated with the WLAN AP.

Example 70 includes the subject matter of any one of Examples 63-69, and optionally, wherein the first device is a service advertiser.

Example 71 includes the subject matter of any one of Examples 63-70, and optionally, wherein the at least one frame comprises at least one ASP session establishment frame to establish the ASP-P2P session.

Example 72 includes the subject matter of any one of Examples 63-71, and optionally, wherein the identifier of the WLAN AP comprises a Basic Service Set Identification (BSSID).

Example 73 includes the subject matter of any one of Examples 63-72, and optionally, wherein the ASP-P2P session comprises a Wireless-Fidelity (Wi-Fi) Direct (WFD) session.

Example 74 includes the subject matter of any one of Examples 63-73, and optionally, wherein the network interface is to communicate with the WLAN AP via a wired or wireless link.

Example 75 includes an apparatus comprising means for establishing at a first device an Application Service Platform (ASP) Peer-to-Peer (P2P) (ASP-P2P) session between the first device and a second device via a WLAN Access Point (AP); and means for communicating with the second device at least one frame of the ASP-P2P session, the frame including an address of the first device, an address of the second device and an identifier of the WLAN AP.

Example 76 includes the subject matter of Example 75, and optionally, comprising means for receiving connectivity information indicating at least one connectivity scheme to connect to the second device, and establishing the ASP-P2P session based on the connectivity information.

Example 77 includes the subject matter of Example 76, and optionally, comprising means for receiving a discovery response frame including the connectivity information.

Example 78 includes the subject matter of Example 77, and optionally, comprising means for receiving the discovery response frame from the second device.

Example 79 includes the subject matter of any one of Examples 76-78, and optionally, wherein the connectivity information includes the identifier of the WLAN AP, the apparatus comprising means for associating with the WLAN AP based on the identifier of the WLAN AP.

Example 80 includes the subject matter of any one of Examples 76-79, and optionally, wherein the connectivity scheme includes a wired or wireless connectivity between the second device and the WLAN AP.

Example 81 includes the subject matter of any one of Examples 76-80, and optionally, wherein the connectivity scheme includes a multi-hop connectivity between the second device and the WLAN AP via at least one other AP.

Example 82 includes the subject matter of any one of Examples 76-81, and optionally, wherein the first device is a service seeker.

Example 83 includes the subject matter of Example 75, and optionally, wherein the first device is a service advertiser, the apparatus comprising means for establishing the ASP-P2P session subsequent to receipt of an indication that the second device is associated with the WLAN AP.

Example 84 includes the subject matter of any one of Examples 75-83, and optionally, wherein the at least one frame comprises at least one ASP session establishment frame to establish the ASP-P2P session.

Example 85 includes the subject matter of any one of Examples 75-84, and optionally, wherein the identifier of the WLAN AP comprises a Basic Service Set Identification (BSSID).

Example 86 includes the subject matter of any one of Examples 75-85, and optionally, wherein the ASP-P2P session comprises a Wireless-Fidelity (Wi-Fi) Direct (WFD) session.

Functions, operations, components and/or features described herein with reference to one or more embodiments, may be combined with, or may be utilized in combination with, one or more other functions, operations, components and/or features described herein with reference to one or more other embodiments, or vice versa.

While certain features have been illustrated and described herein, many modifications, substitutions, changes, and equivalents may occur to those skilled in the art. It is, therefore, to be understood that the appended claims are intended to cover all such modifications and changes as fall within the true spirit of the invention.

What is claimed is:

1. A first device comprising:
a radio to communicate over a Wireless Local Area Network (WLAN); and
a controller to establish an Application Service Platform (ASP) Peer-to-Peer (P2P) (ASP-P2P) session between the first device and a second device via a WLAN Access Point (AP), said radio to communicate at least one frame with said second device via the WLAN AP, the frame including an address of said first device, an address of said second device, and an identifier of said WLAN AP.

2. The first device of claim 1, wherein said controller is to receive connectivity information indicating at least one connectivity scheme to connect to said second device, and to establish the ASP-P2P session based on the connectivity information.

3. The first device of claim 2, wherein said radio is to receive a discovery response frame including the connectivity information.

4. The first device of claim 3, wherein said radio is to receive said discovery response frame from the second device.

5. The first device of claim 2, wherein the connectivity information includes the identifier of said WLAN AP, said controller to associate with said WLAN AP based on the identifier of said WLAN AP.

6. The first device of claim 2, wherein the connectivity scheme includes a wired or wireless connectivity between the second device and the WLAN AP.

7. The first device of claim 2, wherein the connectivity scheme includes a multi-hop connectivity between the second device and the WLAN AP via at least one other AP.

8. The first device of claim 2 being a service seeker.

9. The first device of claim 1 being a service advertiser, the controller to establish the ASP-P2P session subsequent to receipt of an indication that the second device is associated with said WLAN AP.

10. The first device of claim 1, wherein the at least one frame comprises at least one ASP session establishment frame to establish said ASP-P2P session.

11. The first device of claim 1, wherein the identifier of said WLAN AP comprises a Basic Service Set Identification (BSSID).

12. The first device of claim 1, wherein said ASP-P2P session comprises a Wireless-Fidelity (Wi-Fi) Direct (WFD) session.

13. The first device of claim 1 being a mobile device including one or more antennas, a processor, and a memory.

14. A method performed by a first device, the method comprising:
establishing an Application Service Platform (ASP) Peer-to-Peer (P2P) (ASP-P2P) session between the first device and a second device via a WLAN Access Point (AP); and
communicating with said second device at least one frame of said ASP-P2P session, the frame including an address of said first device, an address of said second device and an identifier of said WLAN AP.

15. The method of claim 14 comprising receiving connectivity information indicating at least one connectivity scheme to connect to said second device, and establishing the ASP-P2P session based on the connectivity information.

16. The method of claim 15, wherein the connectivity information includes the identifier of said WLAN AP, the method comprising associating with said WLAN AP based on the identifier of said WLAN AP.

17. A product including one or more tangible computer-readable non-transitory storage media comprising computer-executable instructions operable to, when executed by at least one computer processor, enable the at least one computer processor to implement a method a first device, the method comprising:
establishing an Application Service Platform (ASP) Peer-to-Peer (P2P) (ASP-P2P) session between the first device and a second device via a WLAN Access Point (AP); and
communicating with said second device at least one frame of said ASP-P2P session, the frame including an address of said first device, an address of said second device and an identifier of said WLAN AP.

18. The product of claim 17, wherein the method comprises receiving connectivity information indicating at least one connectivity scheme to connect to said second device, and establishing the ASP-P2P session based on the connectivity information.

19. The product of claim 18, wherein the method comprises receiving a discovery response frame including the connectivity information.

20. The product of claim 18, wherein the connectivity information includes the identifier of said WLAN AP, the method comprising associating with said WLAN AP based on the identifier of said WLAN AP.

21. The product of claim 18, wherein the first device is a service seeker.

22. The product of claim 17, wherein the first device is a service advertiser, the method comprising establishing the ASP-P2P session subsequent to receipt of an indication that the second device is associated with said WLAN AP.

23. A first device comprising:
a network interface to communicate with a Wireless Local Area Network (WLAN) Access point (AP); and
a controller to establish an Application Service Platform (ASP) Peer-to-Peer (P2P) (ASP-P2P) session between the first device and a second device via said WLAN AP, said network interface to communicate at least one frame with said second device via the WLAN AP, the frame including an address of said first device, an address of said second device, and an identifier of said WLAN AP.

24. The first device of claim 23, wherein said controller is to send to said second device connectivity information indicating at least one connectivity scheme to connect to said first device.

25. The first device of claim 23, wherein the at least one frame comprises at least one ASP session establishment frame to establish said ASP-P2P session.
